(19) United States
(12) Patent Application Publication
(10) Pub. No.: US 2026/0290175 A1
(43) Pub. Date: Sep. 24, 2026

(54) ENHANCED RUNWAY UTILIZATION THROUGH CONNECTED SYSTEMS

(71) Applicant: Honeywell International Inc., Charlotte, NC (US)

(72) Inventors: Karthikeyan Mariappan, Madurai (IN); Pradeep Huncha, Bangalore (IN); Gobinathan Baladhandapani, Madurai (IN); Sreenivasan K. Govindillam, Bengaluru (IN)

(21) Appl. No.: 19/209,591

(22) Filed: May 15, 2025

(30) Foreign Application Priority Data
Mar. 18, 2025 (IN) 202511024001

(51) Int. Cl. G08G 5/54; B64D 43/00; B64D 45/00; G08G 5/21

(52) U.S. Cl. CPC G08G 5/54; B64D 43/00; B64D 45/00; G08G 5/21; B64D 2045/0075

(57) ABSTRACT

A system may determine a required landing length (RLL) for an aircraft to land on a runway that intersects a second runway. The system may determine, based on comparing the RLL with an available landing distance (ALD) for the runway that ends before a hold short point of the runway, that the aircraft is able to perform a Land And Hold Short Operation (LAHSO) to land on the runway and stop before the hold short point on the runway. The system may, in response to the aircraft being cleared to perform the LAHSO to land on the runway, determine, based on the ALD for the runway, real-time landing guidance information for the aircraft to perform the LAHSO to land on the runway. The system may output, during performance of the LAHSO by the aircraft, the real-time landing guidance information for performing the LAHSO to land on the runway.

This application claims the benefit of Indian Provisional Patent Application No. 202511024001, filed Mar. 18, 2025, the entire contents of which are incorporated herein by reference.

### TECHNICAL FIELD

This disclosure relates to systems for selecting runways for aircraft landing at an airport.

### BACKGROUND

Airports can include multiple runways, which can increase the airport's capacity, reduce delays, and provide redundancy for the airport. Due to geographic and area constraints, an airport may include one or more intersecting runways, in which the length of one runway may cross the length of another runway. Intersecting runways may introduce operational challenges to airports, such as coordination between aircrafts to avoid conflicts at intersection points of intersection runways.

### SUMMARY

This disclosure describes techniques for assisting an aircraft to perform a Landing And Hold Short Operation (LAHSO). A LAHSO is an air traffic control procedure for aircraft landing and holding short of an intersecting runway or a point on a runway. When landing on a runway of an airport that intersects another runway of the airport, an aircraft may perform a LAHSO to land short of an intersection point of the two runways, to ensure that the aircraft landing on the runway does not interfere with another aircraft that is landing or taking off from the other runway.

A system of an aircraft attempting to land at an airport may, prior to requesting landing clearance, determine one or more runways of the airport on which the aircraft may land. If the airport includes one or more intersecting runways, the system may determine, for a runway of an airport that intersects a second runway, whether the aircraft is able to perform a LAHSO to land on the runway. If the system determines that the aircraft is able to perform a LAHSO to land on a runway, the system may request landing clearance from air traffic control of the airport to perform the LAHSO to land on the runway of the airport. If the system receives clearance for the aircraft to perform the LAHSO land on the runway, the system may perform one or more operations to aid the pilot of the aircraft to perform the LAHSO to land on the intersecting runway short of a designated hold short point, to thereby not interfere with another aircraft that is landing or taking off from the other runway.

In some aspects, the techniques described herein relate to a computer-implemented method including: determining, by processing circuitry of a computing system onboard an aircraft and based on aircraft state information, runway information, and situational data, a required landing length (RLL) for the aircraft to land on a runway that intersects a second runway; determining, by the processing circuitry and based on comparing the RLL with an available landing distance (ALD) for the runway that ends before a hold short point of the runway, that the aircraft is able to perform a Land And Hold Short Operation (LAHSO) to land on the runway and stop before the hold short point on the runway; in response to the aircraft being cleared to perform the LAHSO to land on the runway, determining, by the processing circuitry and based on the ALD for the runway, real-time landing guidance information for the aircraft to perform the LAHSO to land on the runway; and outputting, by the processing circuitry and during performance of the LAHSO by the aircraft, the real-time landing guidance information for performing the LAHSO to land the aircraft on the runway.

In some aspects, the techniques described herein relate to a computing system onboard an aircraft, the computing system including: one or more memories; and processing circuitry coupled to the one or more memories and configured to: determine, based on aircraft state information, runway information, and situational data, a required landing length (RLL) for the aircraft to land on a runway that intersects a second runway; determine, based on comparing the RLL with an available landing distance (ALD) for the runway that ends before a hold short point of the runway, that the aircraft is able to perform a Land And Hold Short Operation (LAHSO) to land on the runway and stop before the hold short point on the runway; in response to the aircraft being cleared to perform the LAHSO to land on the runway, determine, based on the ALD for the runway, real-time landing guidance information for the aircraft to perform the LAHSO to land on the runway; and output, during performance of the LAHSO by the aircraft, the real-time landing guidance information for performing the LAHSO to land the aircraft on the runway.

In some aspects, the techniques described herein relate to a non-transitory computer-readable storage medium including instructions, that when executed by one or more processors of a computing system onboard an aircraft, cause the one or more processors to: determine, based on aircraft state information, runway information, and situational data, a required landing length (RLL) for the aircraft to land on a runway that intersects a second runway; determine, based on comparing the RLL with an available landing distance (ALD) for the runway that ends before a hold short point of the runway, that the aircraft is able to perform a Land And Hold Short Operation (LAHSO) to land on the runway and stop before the hold short point on the runway; in response to the aircraft being cleared to perform the LAHSO to land on the runway, determine, based on the ALD for the runway, real-time landing guidance information for the aircraft to perform the LAHSO to land on the runway; and output, during performance of the LAHSO by the aircraft, the real-time landing guidance information for performing the LAHSO to land the aircraft on the runway.

The details of one or more examples are set forth in the accompanying drawings and the description below. Other features, objects, and advantages will be apparent from the description, drawings, and claims.

### BRIEF DESCRIPTION OF DRAWINGS

FIG. 1 shows an overview of an example computing environment in which techniques of the present disclosure may be implemented.

FIG. 2 illustrates an example of intersecting runways, in accordance with aspects of this disclosure.

FIG. 3 illustrates an example of an electronic flight bag, in accordance with aspects of this disclosure.

FIG. 4 illustrates an example of avionics of an aircraft, in accordance with aspects of this disclosure.

FIG. 5 is a flowchart showing an example process for assisting an aircraft to perform a Landing And Hold Short Operation (LAHSO), in accordance with aspects of this disclosure.

### DETAILED DESCRIPTION

Air traffic control at busy airports may be responsible for coordinating aircraft takeoffs and landings at the multiple runways of the airport in ways that optimize airport operations and resource utilization, In some examples, the air traffic control may perform high intensity runway operations, which aim to reduce runway occupancy time for arriving and departing aircrafts to thereby increase runway capacity.

An airport may include multiple runways, including intersecting runways in which two or more runways intersect with each other. To efficiently utilize such intersecting runways, air traffic control may have to coordinate multiple aircrafts that, simultaneously or in near succession, takeoff from and/or land on runways that intersect each other.

An aircraft may be able to land on a runway that intersect another runway without interfering with another aircraft that is taking off or landing on the intersecting runway if the aircraft is able to perform a Landing And Hold Short Operation (LAHSO) to land short of a hold short point of the runway, such as by landing on the runway and holding the aircraft short of a designated hold short point of the runway. Performing a LAHSO may ensure that the aircraft landing on the runway does not interfere with another aircraft that is landing or taking off from the second runway.

Air traffic control and pilots of aircrafts arriving at the airport may work in tandem to determine which of the arriving aircrafts are able to perform a LAHSO to land on a particular runway. Air traffic control may contact aircrafts approaching the airport to land to request each of the aircrafts to perform a LAHSO to land and a particular runway. Each of the contacted aircraft may, in response to receiving the request, determine whether the aircraft is able to perform the LAHSO to land on the particular runway and transmit, back to air traffic control, whether the aircraft is able to perform the LAHSO to land on the particular runway. Air traffic control may, based on the responses received from the aircrafts, select one of the aircrafts to perform a LAHSO to land on the particular runway.

However, the pilot of an aircraft that receives a request to perform a LAHSO may not have all of the information that may be needed to accurately assess whether the aircraft is able to successfully perform a LAHSO to land on a particular runway. Further, determining whether the aircraft is able to successfully perform a LAHSO to land on a particular runway may increase pilot workload. In addition, when the aircraft is cleared to perform a LAHSO to land on a particular runway, systems of the aircraft may not be able to provide pertinent information to the pilot to successfully perform a LAHSO to land on the particular runway.

In accordance with this disclosure, a system of an aircraft may be configured to determine whether the aircraft is able to perform a LAHSO to land on a runway that intersects another runway of an airport. The system of the aircraft may, based on the aircraft being able to perform a LAHSO to land on a runway, determine aircraft configuration information to perform the LAHSO. The system of the aircraft may also, during landing, output information that guides the pilot to perform the LAHSO.

To determine whether the aircraft is able to perform a LAHSO to land on the runway, the system may determine the required landing length (RLL) for the aircraft to land on the runway and whether the RLL for the aircraft would enable the aircraft to stop prior to a designated hold short point of the runway. The system may determine the RLL for the aircraft to land on a runway based on information such as aircraft state data, runway data, aircraft performance data, situational data, and the like. The system may access such information from sensors of the aircraft, the flight management system of the aircraft, external data sources, such as weather stations, automatic terminal information service stations, and the like.

The system may also determine a designated hold short point for the runway, which may be a point of the runway before the runway intersects another runway. The system may determine an available landing distance for the runway that ends at the hold short point of the runway, and may compare the RLL with the available landing distance to determine whether the aircraft is able to perform the LAHSO to land on the runway. If the system determines that the RLL is less than the available landing distance, the system may determine that the aircraft is able to perform the LAHSO to land on the runway.

If the system determines that the aircraft is able to perform a LAHSO to land on a runway of the airport, the system may request landing clearance from air traffic control of the airport to perform the LAHSO to land on the intersecting runway of the airport. If the system receives clearance for the aircraft to perform the LAHSO land on the intersecting runway, the system may perform one or more operations to aid the pilot of the aircraft to perform the LAHSO to land on the intersecting runway.

The system may, based on the aircraft being cleared to perform a LAHSO to land on a runway, determine landing configuration information for the aircraft to perform the LAHSO to land on the designated runway. Such landing configuration information may include aircraft configuration such as auto brake configuration, reverse thrust setting, slats setting, flaps position, and the like, approach speed, and any other suitable landing configuration. The system may output the determined landing configuration information, so that the pilot may configure the aircraft according to the determined landing configuration information.

The system may also, based on the aircraft being cleared to perform a LAHSO to land on a runway, output landing guidance information that can be used by the pilot to successfully perform the LAHSO operation to land on the runway. The system may take into account the available landing distance for the runway that ends at the hold short point of the runway to determine a glide path for the aircraft to safety land at the designated runway and to stop before reaching the designated hold short point for the runway, and may monitor the aircraft for deviations from the glide path. The system may output real-time landing guidance information based on the glide path and/or deviations from the glide path to assist the pilot to successfully perform the LAHSO operation. Such real-time landing guidance information may include glide scope alerts, runway remaining, stability warnings, ground proximity alerts, surface situation alerts, and the like. The system may also output visual cues to aid the pilot to perform the LAHSO operation.

The techniques of this disclosure may provide one or more potential technical advantages. The system of the aircraft may be able to access sensor data and communicate with external data sources, such as weather stations and automatic terminal information service stations to access and/or collect real-time information such as aircraft state data, runway data, aircraft performance data, situational data, and the like, that enables the system to accurately determine the required landing distance for the aircraft and whether the aircraft is able to perform a LAHSO operation to land on a runway that intersects another runway.

Further, because the system determines the available landing distance for the runway that ends at the hold short point of the runway the system may determine landing guidance information for guiding the pilot to perform the LAHSO in ways that take into account the available landing distance for the runway that ends at the hold short point of the runway. Determining such landing guidance information based on the available landing distance for the runway that ends at the hold short point of the runway enables the system to output more accurate landing guidance information compared to landing guidance information that do not take into account the hold short point of the runway, and may improve the safety of LAHSO performed by the pilot.

The techniques of this disclosure may also reduce fuel usage by aircrafts that attempt to land at an airport. By being able to determine that an aircraft is able to perform a LAHSO to land on an intersecting runway, the techniques of this disclosure enables an aircraft to land on a runway that intersects another runway even when the other runway is in use by another aircraft for takeoff or landing. This may enable the aircraft to not have to remain in the air in a holding pattern until the other aircraft takes off or lands at the other runway, which reduces fuel usage by the aircraft to land at the airport.

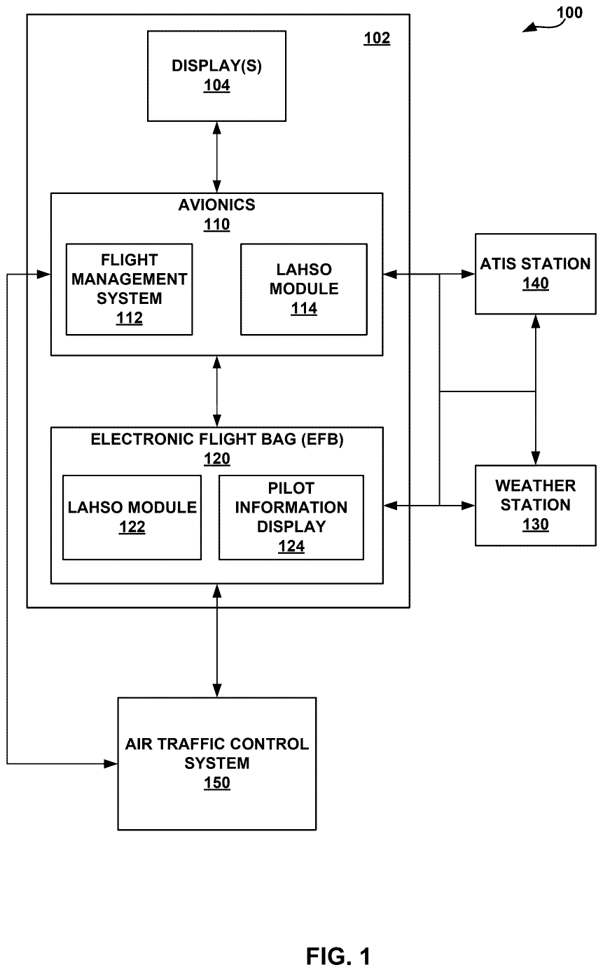

FIG. 1 shows an overview of an example computing environment 100, according to one or more examples of the present disclosure. Environment 100 includes aircraft 102, weather station 130, automatic terminal information service (ATIS) station 140, and Air Traffic Control (ATC) system 150. Aircraft 102 includes electronic flight bag (EFB) 120, avionics 110, and one or more displays 104. EFB 120 is configured to communicate with avionics 110, and avionics 110 is operably coupled to one or more displays 104. One or more displays 104 may be one or more cockpit displays in aircraft 102. EFB 120 and avionics 110 may both be devices or systems that may be located inside aircraft 102. A pilot in cockpit, may have access to applications installed on EFB 120 and may also have access to avionics 110.

EFB 120 may be a computer device, such as a laptop computer, a tablet computer, and the like, carried by a pilot or a flight crew, which may store, for example, navigational charts, maps for air and ground operations of an aircraft, a flight plan management system, an aircraft operating manual, flight-crew operating manual, software applications which automate flight-related or avionics-related computation tasks, and/or any application or data which may be installed in a general purpose computing platform.

EFB 120 may include Landing And Hold Short Operation (LAHSO) module 122. LAHSO module 122 may perform operations described herein using software, hardware, firmware, or a mixture of both hardware, software, and firmware residing in and executing on EFB 120 or at one or more other remote computing devices. In some examples, LAHSO module 122 may be implemented as hardware, software, and/or a combination of hardware and software. EFB 120 may execute LAHSO module 122 with one or more processors.

Avionics 110 may also include LAHSO module 114. LAHSO module 114 may perform operations described herein using software, hardware, firmware, or a mixture of both hardware, software, and firmware residing in and executing on avionics 110 or at one or more other remote computing devices. In some examples, LAHSO module 114 may be implemented as hardware, software, and/or a combination of hardware and software. Avionics 110 may execute LAHSO module 114 with one or more processors.

EFB 120 may include a pilot information display (PID) 124. PID 124 may function as an output device using any one or more of a liquid crystal display (LCD), dot matrix display, light emitting diode (LED) display, microLED, organic light-emitting diode (OLED) display, e-ink, or similar monochrome or color display capable of outputting visible information to the user of EFB 120.

Avionics 110 generally represents any electronic system that may be implemented in an aircraft. Avionics 110 may, for example, perform functions related to communication, navigation, safety monitoring, and other such functionality. Avionics 110 includes FMS 112, which represents a specialized computer system and/or software configured to automate in-flight tasks according to a flight plan.

EFB 120 and avionics 110 are also configured to communicate with weather station 130, ATIS station 140, ATC system 150, as well as any other external stations, systems, and/or devices. ATC system 150 may be any device or system, including communications devices and systems, computing devices and systems, cloud-based systems, data link systems, and the like, used by Air Traffic Control and air traffic controllers to communicate with pilots and aircrafts. ATC system 150 may communicate with EFB 120 and avionics 110 via any suitable communication technique, such as radio communication (e.g., voice communication via radio link), digital communication, controller-pilot data link communications, data communications, and the like.

In accordance with aspects of this disclosure, aircraft 102 may, prior to landing at an airport, determine whether aircraft 102 is able to perform a LAHSO to land on an intersecting runway of the airport. If aircraft 102 determines that it is able to perform a LAHSO to land on an intersecting runway of the airport, aircraft 102 may request landing clearance from Air Traffic Control, such as by communicating with ATC system 150, to perform the LAHSO to land on the intersecting runway of the airport. If aircraft 102 receives clearance to land on the intersecting runway, EFB 120 and/or avionics 110 of aircraft 102 may perform one or more operations to aid the pilot of the aircraft 102 to perform the LAHSO.

EFB 120 and/or avionics 110 may be configured to determine, for each of one or more runways of an airport, a respective RLL for aircraft 102 to land on the runway. EFB 120 and/or avionics 110 may be configured to determine a respective RLL for each operational runway of the airport, for each operational intersecting runway of the airport, or for any other combination of one or more operational runways of the airport.

Before landing, the pilot of aircraft 102 may interact with EFB 120 and/or avionics 110 to enable a LAHSO setting, which indicates an intention to perform LAHSO procedures to land at the airport. The pilot of aircraft 102 may enable the LAHSO setting prior to receiving an indication (e.g., a broadcast from ATC system 150) that LAHSO is in effect at the airport. LAHSO module 122 or LAHSO module 114 may, in response to the LAHSO setting being activated, evaluate each of one or more runways, including one or more intersecting runways, to identify one or more runways that are suitable for landing by aircraft 102. Evaluating each of the one or more runways include calculating a respective RLL for each of the one or more runways. LAHSO module 122 or LAHSO module 114 may calculate the RLL for a runway based on information such as runway surface conditions, Digital Automatic Terminal Information Service (D-ATIS) information (e.g., from ATIS station 140), situational data (e.g., weather data from weather station 130), current aircraft state data, and/or any other suitable information.

Each runway may have an Available Landing Distance (ALD), also referred to as Landing Distance Available (LDA), which is the length of the runway that is declared available and suitable for the ground run of an aircraft landing. LAHSO module 122 or LAHSO module 114 may compare the RLL for a runway with the ALD for the runway. If LAHSO module 122 or LAHSO module 114 determines that the RLL for a runway is less than or equal to the runway's ALD, LAHSO module 122 or LAHSO module 114 may determine that the runway is eligible for landing selection by aircraft 102.

In the case of intersecting runways, LAHSO module 122 may also determine, for a runway that intersects another runway, a designated hold short point of the runway. In some examples, LAHSO module 122 or LAHSO module 114 may determine a designated hold short point of a runway by referencing a database, such as an Airport Moving Map Database (AMMDB), containing such information. LAHSO module 122 or LAHSO module 114 may determine whether the RLL for the runway enables aircraft 102 to safely stop before reaching the designated hold short point for the runway. For example, LAHSO module 122 or LAHSO module 114 may adjust the ALD of a runway to correspond to the designated hold short point for the runway and may determine, based on the adjusted ALD of the runway, whether the RLL for the runway enables aircraft 102 to safely stop before reaching the designated hold short point for the runway. LAHSO module 122 or LAHSO module 114 may, based on determining that the RLL for the runway enables aircraft 102 to safely stop before reaching the designated hold short point for the runway, determine whether the runway is eligible for landing selection by aircraft 102.

EFB 120 and/or avionics 110 in aircraft 102 may be configured to transmit, to ATC system 150, indications of an intersecting runway of the airport on which aircraft 102 can land. EFB 120 and/or avionics 110 may, in some examples, transmit the indication of the intersecting runway as part of a landing clearance request to request clearance to land on the indicated runway. The landing clearance request may be a LAHSO clearance request to request clearance to perform a LAHSO to land on the runway and to hold short of the designated hold short point for the runway.

As can be seen, EFB 120 and/or avionics 110 in aircraft 102 may be able to initiate a request for LAHSO landing clearance, in contrast to techniques in which ATC system 150 initiates a LAHSO clearance request. That is, EFB 120 and/or avionics 110 may be able to determine whether aircraft 102 is able to perform a LAHSO to land on a particular runway and, if so, initiate a request for LAHSO landing clearance for the particular runway without having received a LAHSO clearance request from air traffic control.

ATC system 150 may receive the indication of the runway on which aircraft 102 can land, such as by receiving the landing clearance request, and may, in response, transmit, to EFB 120 and/or avionics 110, landing clearance for aircraft 102 to land on the indicated runway. Such a landing clearance may be a LAHSO clearance that clears aircraft 102 to perform a LAHSO to land on the runway and to hold short of the designated hold short point for the runway.

EFB 120 and/or avionics 110 may, in response to receiving the landing clearance to land on the runway, automatically synchronize approach information for landing on the runway with FMS 112 and/or applications of avionics 110. The approach information may include navigation and guidance data for landing on the runway.

EFB 120 and/or avionics 110 may also adjust the ALD for the runway based on the designated hold short point for the runway. For example, EFB 120 and/or avionics 110 may adjust the ALD for the runway so that the ALD for the runway ends at or before the designated hold short point for the runway, instead of the full length of the runway. EFB 120 and/or avionics 110 may provide the information regarding the RLL and adjusted ALD to supplementary runway alerting and advisory systems of avionics 110, such as a Runway Awareness and Advisory System (RAAS), a Runway Overrun Awareness and Alerting System (ROAAS), and the like.

EFB 120 and/or avionics 110 may output landing information used by the pilot of aircraft 102. EFB 120 and/or avionics 110 may output the landing information for display at one or more displays, such as the PID 124 of EFB 120 and/or one or more displays 104 coupled to avionics 110. Such landing information may include runway selection information, landing parameters, and the like. Presenting the landing information at the one or more displays may enable the flight crew of aircraft 102 to select and/or synchronize the chosen landing approach with the onboard landing system.

EFB 120 and/or avionics 110 may also determine landing configuration information for aircraft 102 to perform the LAHSO to land on the designated runway, and may output the determined landing configuration information. EFB 120 and/or avionics 110 may output the landing configuration for display at one or more displays, such as the PID 124 and/or one or more displays 104. The landing configuration information may include aircraft configuration such as auto brake configuration, reverse thrust setting, slats setting, flaps position, and the like, approach speed, and any other suitable landing configuration.

EFB 120 and/or avionics 110 may monitor aircraft 102 in real-time as aircraft 102 descends to land on the designated runway and may output real-time landing guidance information to the pilot of aircraft 102. EFB 120 and/or avionics 110 may determine a glide path for aircraft 102 to safety land at the designated runway and to stop before reaching the designated hold short point for the runway. EFB 120 and/or avionics 110 may, based on the glide path, monitor aircraft 102 for deviations from the glide path. EFB 120 and/or avionics 110 may therefore determine real-time landing guidance information based on the glide path and/or deviations from the glide path.

The real-time landing guidance information may include glide slope alerts (e.g., “too low”, “too high”, “unstable”, etc.), altitude callouts (e.g., “100 feet”, “50 feet”, etc.), runway status and runway remaining (e.g., 500 feet) to the designated hold short point for the runway, stability warnings, ground proximity alerts, surface situation alerts, visual cues, and the like. EFB 120 and/or avionics 110 may output such real-time landing guidance information by outputting audio (e.g., voice output) that contains such real-time landing guidance information at one or more audio output devices (e.g., a speaker device, a headset, etc.) of aircraft 102, and/or may output such real-time landing guidance information for display at PID 124 and/or one or more displays 104.

As indicated above, FIG. 1 is provided merely as an example. Other examples are possible and may differ from what was described with regard to FIG. 1. The number and arrangement of devices and networks shown in FIG. 1 are provided as an example. In practice, there may be additional devices, fewer devices and/or networks, different devices and/or networks, or differently arranged devices and/or networks than those shown in FIG. 1. Furthermore, two or more devices shown in FIG. 1 (e.g., EFB 120 and FMS 112) may be implemented within a single device, or a single device shown in FIG. 1 (e.g., EFB 120 or FMS 112) may be implemented as multiple, distributed devices. Additionally, or alternatively, a set of devices (e.g., one or more devices) of environment 100 may perform one or more functions described as being performed by another set of devices of environment 100.

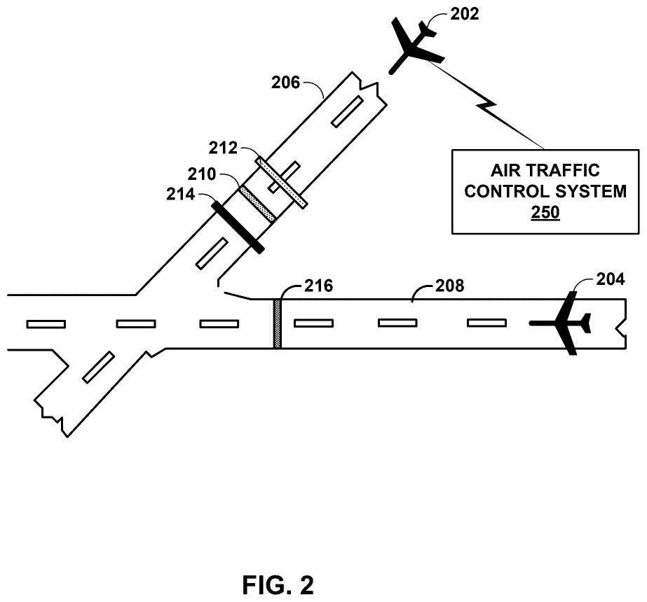

FIG. 2 illustrates an example of intersecting runways. As shown in FIG. 2, runway 206 intersects runway 208. Thus, runways 206 and 208 are intersecting runways. Because runways 206 and 208 are intersecting runways, runway 206 has a hold short point 210, and runway 208 has a hold short point 216. Aircraft 202, which is an example of aircraft 102 of FIG. 1, may attempt to land on runway 206 while aircraft 204 is cleared to land on the full length of runway 208. Due to the full length of runway 208 being in use by aircraft 204, aircraft 202 may be cleared to land on runway 206 only if aircraft 202 is able to perform a LAHSO to land on runway 206 and stop prior to hold short point 210.

A system of aircraft 202, such as the avionics of aircraft 202 and/or an EFB, may determine the RLL for aircraft 202 to land on runway 206. If the system determines that the RLL for aircraft 202 ends at point 212 of runway 206, which is short of hold short point 210 of runway 206, the system may determine that aircraft 202 is able to perform a LAHSO to land on runway 206. The system may, based on determining that aircraft 202 is able to perform a LAHSO to land on runway 206, send to air traffic control system 250, which is an example of air traffic control system 150 of FIG. 1, a request landing clearance to land on runway 206.

If the system determines that the RLL for aircraft 202 extends past hold short point 210 of runway 206, such as by ending at point 214 of runway 206, the system may determine that aircraft 202 is not able to perform a LAHSO to land on runway 206. The system may, based on determining that aircraft 202 is not able to perform a LAHSO to land on runway 206, refrain from sending a request to air traffic control system 250 for landing clearance to land on runway 206.

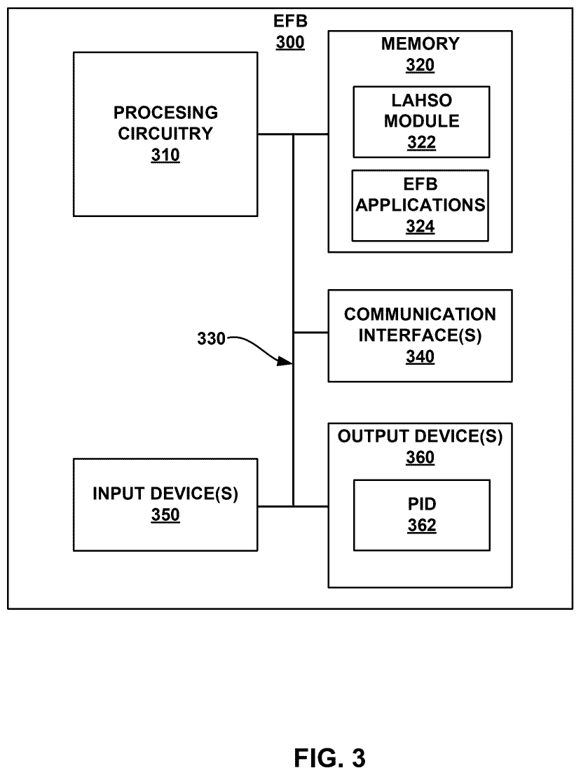

FIG. 3 illustrates an example of EFB 300, in accordance with aspects of this disclosure. EFB 300 is an example of EFB 120 shown in FIG. 1.

EFB 300 may be any sort of generic computing hardware, such as a tablet computer, phone, laptop computer, desktop computer, or other such computing device, that is configured to store and execute EFB applications. In other examples, EFB 300 may be specialized computing hardware configured to store and execute EFB applications. Some EFBs may be portable and be able to be carried from plane to plane, while other EFBs may be permanently mounted in a specific airplane. In the example of FIG. 3, EFB 300 includes processing circuitry 310, memory 320 which stores LAHSO module 322, which is an example of LAHSO module 122 shown in FIG. 1, and EFB applications 324, and communication interface(s) 340 to communicate with other devices.

Processing circuitry 310 implements the functionality of and/or executes the instructions associated with LAHSO module 322 and EFB applications 324. Processing circuitry 310 may be implemented as any of a variety of suitable circuitry that includes a processing system, such as one or more integrated circuits, microprocessors, DSPs, ASICs, FPGAs, discrete logic, software, hardware, firmware, or any combinations thereof. When the techniques are implemented partially in software, EFB 300 may store instructions for the software in a suitable, non-transitory computer-readable storage medium (e.g., memory 320) and execute the instructions in hardware using processing circuitry 310 to perform the techniques of this disclosure.

Memory 320 is intended to generically represent all memory included within EFB 300. In some implementations, memory 320 may include a plurality of separate devices and memory units. These memory devices and memory units may include volatile memory, such as RAM), and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned EFB application (shown in FIG. 3 as EFB applications 324) and LAHSO module 322 may be stored in any volatile and/or non-volatile memory component of memory 320.

EFB 300 also includes input device(s) 350 (e.g., a keyboard, mouse, or touchscreen) and output device(s) 360 (e.g., a display, printer). Output device(s) 360 may be or include PID 362, which is an example of PID 124 shown in FIG. 1. In implementations where EFB 300 is a phone or tablet computer, then the EFB may, for example, have a touchscreen and a display, such as in the form of PID 362. In implementations where EFB 300 is a larger computer device, then the EFB may, for example, have a mouse, trackpad, keyboard, or other such input devices. The aforementioned components of EFB 300 may be connected to one another through a bus 330, which generally represents one or more busses and is intended to generically represent all the electrical and data connectivity of internal components included within EFB 300.

Communication interface(s) 340 generally represents all hardware, e.g., transceiver circuitry, within EFB 300 for communicating with external devices, such as avionics of an aircraft and/or with external systems, such as an air traffic control system. Communication interface(s) 340 may facilitate communication with external devices and systems via one or more wired and/or wireless network connections by transmitting and/or receiving signals on the one or more networks. Examples of communication interface(s) 340 include a network interface card (e.g., such as an Ethernet card), an optical transceiver, a radio frequency transceiver, a GPS receiver, or any other type of device that can send and/or receive information. Other examples of communication interface(s) 344 may include short wave radios, cellular data radios, wireless network radios, as well as universal serial bus (USB) controllers. In some examples, communication interface(s) 344 may include an avionics full-duplex switched ethernet (AFDX) interface.

EFB applications 324 represent a suite of software tools that may be used by a pilot in managing flight operations. EFB applications 324 may include flight planning applications that allow pilots to create and file flight plans, access weather information, and calculate fuel requirements. EFB applications 324 may also include navigation applications that provide real-time navigation support with maps, airspace information, and waypoint management. EFB applications 324 may also include weather applications that provide real-time weather data, future weather predictions, radar imagery, and the like. EFB applications 324 may also include checklist applications for ensuring compliance with pre-flight, mid-flight, and post-flight procedures. EFB applications 324 may also include various performance analysis tools that, for example, help pilots compute takeoff and landing distances based on current conditions and aircraft configuration. EFB applications 324 may also include aircraft maintenance tracking tools that track aircraft maintenance schedules, inspection records, and compliance records. EFB applications 324 may also include flight logbooks that enable pilots to log flights, track hours, and generate reports for currency and certification. EFB applications 324 may also include airport information applications that provide information about airports, including runway layouts, services, and notices.

In accordance with aspects of this disclosure, processing circuitry 310 of EFB 300 onboard an aircraft that is approaching an airport may be configured to receive, via input device(s) 350, user input that corresponds to enabling a LAHSO setting. Processing circuitry 310 may be configured to, in response to receiving the user input that corresponds to enabling a LAHSO setting, execute LAHSO module 322 to evaluate each of one or more runways of the airport, including one or more intersecting runways, to identify one or more runways of the airport that are suitable for landing by the aircraft.

Processing circuitry 310 may be configured to execute LAHSO module 322 to calculate a respective RLL for each of the one or more runways under evaluation based on information such as runway surface conditions, Digital Automatic Terminal Information Service (D-ATIS) information, situational data, current aircraft state data, and/or any other suitable information. LAHSO module 322 may determine and/or retrieve such information by accessing one or more external data sources, such as databases stored in the avionic and/or the flight management system of the aircraft, and/or one or more external systems (e.g., using interface(s) 340), such as weather station 130 and/or ATIS station 140 shown in FIG. 1.

The situational data used by LAHSO module 322 to calculate the RLL for the aircraft to land on a runway may include wind direction and speed, outside air temperature, dew point, air pressure, visibility, and the like. LAHSO module 322 may access such runway information may receiving a Meteorological Aerodrome Report (METAR) and/or D-ATIS information from weather station 130 and/or ATIS station 140.

The runway surface conditions of a runway used by LAHSO module 322 to calculate the RLL for the aircraft to land on a runway may include static runway information such as runway elevation, runway slope, runway dimensions, runway coordinates and thresholds, runway surface type, and the like. LAHSO module 322 may access such runway information from data sources such as a navigational database (NavDB) in the avionics (e.g., avionics 110 shown in FIG. 1) of the aircraft.

The runway surface conditions of a runway used by LAHSO module 322 to calculate the RLL for the aircraft to land on a runway may also include dynamic runway information such as a runway friction measurement, runway contamination information (e.g., ice, snow, slush, standing water, etc.), a runway moisture level, and the like. LAHSO module 322 may communicate with external systems, such as ATIS station 140 and/or weather station 130 shown in FIG. 1 via communication interface(s) 340, to receive such runway information.

The current aircraft state data used by LAHSO module 322 to calculate a respective RLL for the aircraft to land each of the one or more runways may include the aircraft category, aircraft type, aircraft weight, current aircraft speed, aircraft configuration, thrust reverser health, brake system health, and the like. In some examples, LAHSO module 322 may access the flight management system (e.g., FMS 112 shown in FIG. 1) of the aircraft to access aircraft category and/or aircraft type, planned and current speeds of the aircraft, current flight plan data, and the like. LAHSO module 322 may also access various on-board systems and sensors of the aircraft, such as aircraft weight and balance system, air data computers, landing gear and aircraft configuration sensors, an electronic centralized aircraft monitor (ECAM), brake control systems, aircraft condition monitoring system, central maintenance computers, centralized aircraft monitoring systems, and the like to determine current aircraft state data such as aircraft configuration, thrust reverser health, brake system health, and the like.

Processing circuitry 310 may be configured to execute LAHSO module 322 to determine a respective Available Landing Distance (ALD), also referred to as Landing Distance Available (LDA), which is the length of the runway that is declared available and suitable for the ground run of an aircraft landing, for each of the runways under evaluation. In some examples, the NavDB of the aircraft may store the ALDs of runways, and LAHSO module 3223 may access the NavDB to lookup or otherwise determine the respective ALDs for each of the runways under evaluation.

One or more of the runways being evaluated by LAHSO module 322 may be intersecting runways in which the runway intersects another runway. Processing circuitry 310 may be configured to execute LAHSO module 322 to determine, for each intersecting runway being evaluated, a designated hold short point of the runway. In some examples, an Airport Moving Map Database (AMMDB), which may be stored in memory 320 of EFB 300 or in the avionics of the aircraft, may store information regarding the designated hold short points of runways, and LAHSO module 322 may access the AMMDB to lookup or otherwise determine respective hold short points for each of the intersecting runways under evaluation. LAHSO module 322 may adjust the respective ALD for each of the intersecting runway based on the designated hold short point for the intersecting runway so that, for each intersecting runway, the respective ALD ends at or before the designated hold short point for the intersecting runway.

Processing circuitry 310 may be configured to execute LAHSO module 322 to compare, for each of the runways under evaluation, the RLL for the aircraft to land on the runway against the ALD of the runway. In case of intersecting runways, the respective ALD of each of the intersecting runways may be an adjusted ALD that end at or before the designated hold short point for the intersecting runway, as described above. LAHSO module 322 may determine, for each of the runways under evaluation, whether the RLL for the aircraft to land on the runway is shorter than the ALD of the runway. If LAHSO module 322 determines that the RLL for the aircraft to land on a runway is shorter than the ALD of the runway, LAHSO module 322 may determine that the runway is eligible for landing selection by the aircraft.

LAHSO module 322 may therefore determine, based on comparing, for each of one or more intersecting runways under evaluation, the RLL for the aircraft to land on the respective intersecting runway and the adjusted ALD of the respective intersecting runway, an intersecting runway on which the aircraft can land and hold short of the designated hold short point of the intersecting runway.

Processing circuitry 310 may be configured to execute LAHSO module 322 to transmit, via communication interface(s) 340 and to the ATC system for the airport, an indication of the intersecting runway of the airport on which the aircraft can land and hold short of the designated hold short point of the intersecting runway. In some examples, LAHSO module 322 may transmit the indication of the intersecting runway as part of a landing clearance request to request clearance to land on the indicated runway. The landing clearance request may be a LAHSO clearance request to request clearance to perform a LAHSO to land on the runway and to hold short of the designated hold short point for the runway.

Processing circuitry 310 may be configured to execute LAHSO module 322 to, in response to receiving the landing clearance to land on the runway, automatically synchronize approach information for landing on the runway with the flight management system of the aircraft and/or applications of the avionics of the aircraft. The approach information may include navigation and guidance data for landing on the runway. Processing circuitry 310 may also be configured to execute LAHSO module 322 to provide the information regarding the RLL and adjusted ALD to supplementary runway alerting and advisory systems of the aircraft, such as a Runway Awareness and Advisory System (RAAS), a Runway Overrun Awareness and Alerting System (ROAAS), and the like.

Processing circuitry 310 may be configured to execute one or more of EFB applications 324 to output landing information used by the pilot of the aircraft. One or more of EFB applications 324 may output the landing information for display at one or more displays, such as the PID 362. Such landing information may include runway selection information, landing parameters, and the like. Presenting the landing information at the one or more displays may enable the flight crew of aircraft 102 to select and/or synchronize the chosen landing approach with the onboard landing system.

Processing circuitry 310 may also be configured to execute one or more of EFB applications 324 to determine landing configuration information for the aircraft to perform the LAHSO to land on the designated runway, and may output the determined landing configuration information (e.g., at output device(s) 360 such as for display at PID 362). The landing configuration information may include aircraft configuration such as auto brake configuration, reverse thrust setting, slats setting, flaps position, and the like, approach speed, and any other suitable landing configuration.

The one or more of EFB applications 324 monitor the aircraft in rea-time as the aircraft descends to land on the designated runway, and to output real-time landing guidance information to the pilot of the aircraft. The one or more of EFB applications 324 may determine a glide path for the aircraft to safety land at the designated runway and to stop before reaching the designated hold short point for the runway. The one or more of EFB applications 324 may, based on the glide path, monitor the aircraft for deviations from the glide path, and may therefore determine real-time landing guidance information based on the glide path and/or deviations from the glide path.

The real-time landing guidance information may include glide slope alerts (e.g., “too low”, “too high”, “unstable”, etc.), altitude callouts (e.g., “100 feet”, “50 feet”, etc.), runway status and runway remaining (e.g., 500 feet) to the designated hold short point for the runway, stability warnings, ground proximity alerts, surface situation alerts, visual cues, and the like. Such visual cues may include a glide scope indicator that indicates the pilot to pitch the nose of the aircraft up if one or more of EFB applications 324 determines that the aircraft is below the glide path, or that indicates the pilot to pitch the nose of the aircraft down if one or more of EFB applications 324 determines that the aircraft is above the glide path. The visual cues may also include flight director bars that provide pitch and roll commands for the aircraft to return to glide path, deviation indicators that graphically show glide path deviation, and the like. The one or more of EFB applications 324 may output such real-time landing guidance information by outputting audio (e.g., voice output) that contains such real-time landing guidance information at one or more audio output devices (e.g., a speaker device, a headset, etc.) of output device(s) 360, and/or may output such real-time landing guidance information for display at PID 362.

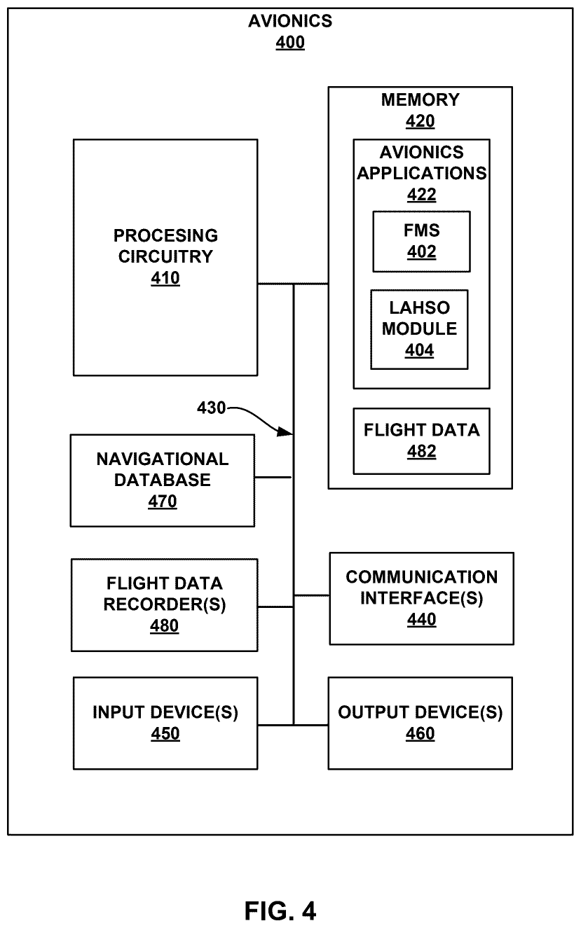

FIG. 4 illustrates an example of avionic 400 of an aircraft, in accordance with aspects of this disclosure. Avionics 400 is specialized computing hardware of an aircraft configured to store and execute avionics applications, and is an example of avionics 110 of aircraft 102 shown in FIG. 1.

In the example of FIG. 4, avionics 400 includes processing circuitry 410, memory 420 which stores avionics applications 422 and flight data 472, and communication interface(s) 440 to communicate with other devices, such as EFB 120 shown in FIG. 1 or EFB 300 shown in FIG. 3, and with other systems, such as weather station 130, ATIS station 140, and/or ATC system 150 shown in FIG. 1. Avionics 400 also includes input device(s) 450, output device(s) 460, navigational database 470, and flight data recorder(s) 480. The aforementioned components of avionics 400 may be connected to one another through a bus 430, which generally represents one or more busses and is intended to generically represent all the electrical and data connectivity of internal components included within avionics 400.

Processing circuitry 410 implements the functionality of and/or executes the instructions associated with avionics applications 422. In the example of FIG. 4, avionics applications 422 includes flight management system (FMS) 402, which is an example of FMS 112 shown in FIG. 1, and LAHSO module 404, which is an example of LAHSO module 114 shown in FIG. 1. Processing circuitry 410 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware, or any combinations thereof. When the techniques are implemented partially in software, avionics 400 may store instructions for the software in a suitable, non-transitory computer-readable storage medium (e.g., memory 420) and execute the instructions in hardware using processing circuitry 410 to perform the techniques of this disclosure.

Memory 420 is intended to generically represent all memory included within avionics 400. In some implementations, memory 420 may include a plurality of separate devices and memory units. Theses memory devices and memory units may include volatile memory, such as RAM, and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). Avionics applications 422 may be stored in any volatile and/or non-volatile memory component of memory 420.

Communication interface(s) 440 generally represents all hardware e.g., transceiver circuitry, within avionics 400 for communicating with external devices either on the ground or while in flight. Communication interface(s) 440 may facilitate communication with external devices via one or more wired and/or wireless network connections by transmitting and/or receiving signals on the one or more networks. Examples of communication interface(s) 440 include a network interface card (e.g., such as an Ethernet card), an optical transceiver, a radio frequency transceiver, a GPS receiver, or any other type of device that can send and/or receive information. Other examples of communication interface(s) 440 may include short wave radios, cellular data radios, wireless network radios, as well as USB controllers. Examples of communication interface(s) 440 for in-flight communication include a very high frequency (VHF) radio, a high frequency (HF) radio, or a satellite communication (SATCOM) radio.

Examples of communication interface(s) 440 used for data links include an aircraft communications addressing and reporting system (ACARS) for providing a digital data link system that allows for the exchange of messages between the aircraft and ground stations for purposes such as flight plan updates, weather information, and maintenance reports. Another examples of communication interface(s) 440 used for data links include controller-pilot data link communications (CPDLC) which allows air traffic control to send instructions and receive acknowledgments from pilots via text messages. Communications interface(s) 440 may also include an automatic dependent surveillance-broadcast transponder. The various examples of communications interfaces listed above represent a non-exhaustive list of the types of the types of communication interfaces that may be included in communication interface(s) 440.

Avionics 400 also includes input device(s) 450 and output device(s) 460. Examples of input device(s) 450 include control display units (CDUs) with alphanumeric keypads or touchscreens to enter flight plans, waypoints, and other necessary data. Input device(s) 450 may also include a flight management system control panel for entering information to the flight management system, such as route, altitude, and speed using dedicated buttons, knobs, and touchscreen interfaces. Input device(s) 450 may also include yoke or sidestick controls as well as touchscreen interfaces. Input device(s) 450 may also include rotary knobs for setting values for altitudes, speeds, and other parameters and toggle switches for selecting modes or turning systems on and off.

Examples of output device(s) 460 may include an electronic flight instrument display to provide visual representations of flight data, including altitude, airspeed, heading, and attitude. Output device(s) 460 may also include a Heads-Up Display (HUD) that projects critical flight information onto a transparent screen in the pilot's line of sight or other cockpit displays to show navigation maps, engine parameters, system statuses, and the like. Output device(s) 460 may also include a vertical situation display configured to show a vertical profile of a flight path. Output device(s) 460 may also include engine instrumentation displays to display data on engine performance, such as temperature, pressure, and revolutions per minute (RPMs). Output device(s) 460 may also include audio panels to relay communication from radios and alerts from systems to the cockpit. Output device(s) 460 may also include a flight management system display to show flight plan information and performance data, as well as a traffic collision avoidance system (TCAS) display to alert pilots to nearby aircraft and potential collision threats.

The various examples of input and output devices listed above represent a non-exhaustive list of the types of the types of input and output devices that may be included in input device(s) 450 and output device(s) 460. Additionally, input and output functionality of avionics 400 may facilitated by external devices that are separate from input device(s) 450 and output device(s) 460. For example, EFB 120 shown in FIG. 1 may be configured to input data to and output data for avionics 400.

Avionics applications 422 represent a suite of software tools that may be used by a pilot in managing flight operations and managing the aircraft while in flight. As discussed above, avionics applications 422 include FMS 402, LAHSO module 404, as well as other applications for communication, navigation, and monitoring within an aircraft. Avionics applications 422, for example, include applications for processing and displaying weather radar data and presenting essential flight information such as altitude, airspeed, attitude, and heading to a pilot. Avionics applications 422 also include various safety applications related to surveillance systems (e.g., transponders to communicate the aircraft's identity and altitude to air traffic control and other aircraft, such as automatic dependent surveillance-broadcast (ADS-B) systems that provide real-time data to air traffic control and other aircraft). Avionics applications 422 may also include the software to manage various emergency systems (e.g., an emergency locator transmitter, flight data recorder, and cockpit voice recorder) and cabin management systems (e.g., passenger infotainment systems and environmental control systems).

Navigational database (NavDB) 470 represents a specialized database that stores information needed by FMS 112 for the navigation and operation of an aircraft for purposes such as flight planning, route management, and ensuring safe navigation throughout a flight. Navigational database 470 may, for example, store waypoints, airways, navigational aids, airport information, standard instrument departures (SIDs) and standard terminal arrival routes (STARs), route data, and flight plans. The waypoints represent information on predefined geographical locations used for navigation, including both en-route waypoints and arrival/departure waypoints. The airways are data defining structured flight paths in the sky, including various air routes and connecting points. The navigational aids may, for example, be information on radio beacons, such as VHF Omnidirectional Range and Instrument Landing Systems that assist pilots in navigation. The airport information may, for example, include details about airports, including runway configurations, elevation, communications frequencies, and available approaches. SIDs and STARs may provide standardized paths for departures and arrivals. The route data may, for example, include information on preferred routes, including distance and estimated times. The flight data may be data regarding planned routes, altitudes, and waypoints for a specific flight. The locations of waypoints, airports, and navigational aids may, for example, be defined by geographical coordinates.

Navigational database 470 may also store information related to restrictions and procedures, performance data, and weather information. The restrictions and procedures may include airspace restrictions, no-fly zones, and specific procedures that need to be followed during flight. The performance data may include information related to aircraft performance, including altitude constraints, and speed limits. The weather information may include relevant meteorological data that might affect flight paths, such as wind patterns or turbulence zones. Navigational database 470 may be regularly updated to reflect changes in air traffic regulations, airport information, and navigational aids to ensure pilots have current information for safe and efficient flight operations.

Although not explicitly shown in FIG. 4, avionics 400 may include or be in communication with numerous other hardware components or hardware systems, such as a global positioning system (GPS) receiver, an inertial navigation system (INS) that includes gyroscopes and accelerometers to calculate position based on movement, weather radar for detecting weather patterns, engine monitoring systems, aircraft data recording systems, flight data recording systems, and other such systems. In some examples, avionics 400 may be configured to utilize inputs from a variety of specialized sensors such as altitude sensors, airspeed sensors, attitude sensors, heading sensors, GPS sensors, temperature sensors, pressure sensors, fuel sensors, weight and balance sensors, navigation sensors, environmental sensors, collision avoidance sensors, and other such sensors.

Flight data recorder(s) 480 may be configured to record, and store in memory 420, flight data 482. In some examples, flight data recorder(s) 480 may have dedicated memory, meaning the memory that stores flight data 482 is separate than, for example, the memory that stores avionics applications 422. Flight data recorder(s) 480 may include any combination of one or more flight data recorders including a quick access recorder, a deployable recorder, or a combined cockpit voice recorder and flight data recorder.

Flight data recorder(s) 480 may be configured to record flight dynamics and motion data. For example, flight data recorder(s) 480 may be configured to record the aircraft's altitude above sea level (i.e., altitude), the aircraft's speed relative to the surrounding air (i.e., airspeed), the aircraft's rate of ascent or descent (i.e., vertical speed), the direction the aircraft is pointed (i.e., heading), the aircraft's nose angle up/down and bank angle left/right (i.e., pitch and roll), the aircraft's deviation from a straight path or wind drift (i.e., yaw), and the aircraft's lateral, vertical, and longitudinal acceleration.

Flight data recorder(s) 480 may also be configured to record control surfaces and positioning data. For example, flight data recorder(s) 480 may be configured to record the aircraft's aileron position for controlling roll, the aircraft's elevator position for controlling pitch, the aircraft's rudder position for controlling yaw, the aircraft's flap positions for controlling changes in lift and drag (e.g., during takeoff, landing, and approach), the aircraft's spoiler positions for reducing lift and slowing the aircraft down, or the aircraft's slat positions for providing added lift during low-speed operations.

Flight data recorder(s) 480 may also be configured to record engine parameters. For example, flight data recorder(s) 480 may be configured to record the aircraft's engine output (e.g., engine thrust or power level), the aircraft engine's core and fan shaft speeds (i.e., N1 and N2 speeds), temperature of gases exiting the engine (e.g., exhaust gas temperature (EGT)), the rate at which fuel is consumed by each engine (i.e., fuel flow rate), oil Pressure, oil temperature, and thrust level set by the pilot (e.g., throttle position).

Flight data recorder(s) 480 may also be configured to record environmental conditions data. For example, flight data recorder(s) 480 may be configured to record outside air temperature, the presence of ice on wings or other critical surfaces, storm and weather information, and wind speed and direction.

Flight data recorder(s) 480 may also be configured to record aircraft systems and equipment data. For example, flight data recorder(s) 480 may be configured to record autopilot Status, such whether autopilot is engaged and what mode (altitude hold, heading mode, etc.) is being implemented. Flight data recorder(s) 480 may also be configured to record the position of the landing gear (e.g., up, down, or transit), brake pressure or braking force applied during landing, hydraulic pressure of braking systems, and cabin altitude and pressurization levels. Flight data recorder(s) 480 may also be configured to record electrical systems status, such as voltage, current, and operational state of systems.

Flight data recorder(s) 480 may also be configured to record flight path and navigation data, such as GPS position (e.g., latitude, longitude, and altitude coordinates), horizontal track and descent/ascent angles (i.e., flight path angle and track), speed relative to the ground (i.e., groundspeed), and navigation waypoints in the flight plan.

Flight data recorder(s) 480 may also be configured to record crew inputs. For example, flight data recorder(s) 480 may be configured to record control inputs, such as a pilot's inputs on yoke/stick, rudder pedals, and throttle. Flight data recorder(s) 480 may also be configured to record status or positions of switches (e.g., fuel pumps, anti-ice). Flight data recorder(s) 480 may also be configured to record communication controls, such as transponder codes, frequency changes, and communications status.

Flight data recorder(s) 480 may also be configured to record the status of warning and alarm systems, such as the status of alarms such as stall warnings, overspeed warnings, or terrain awareness warnings. Flight data recorder(s) 480 may also be configured to record engine and system alerts, such as malfunction notifications related to engine failures, low hydraulic pressures, or other such warnings. Flight data recorder(s) 480 may also be configured to record crew announcements and chimes.

In accordance with aspects of this disclosure, processing circuitry 410 of avionics 400 onboard an aircraft that is approaching an airport may be configured to receive, via input device(s) 450, user input that corresponds to enabling a LAHSO setting. Processing circuitry 410 may be configured to, in response to receiving the user input that corresponds to enabling a LAHSO setting, execute LAHSO module 404 to evaluate each of one or more runways of the airport, including one or more intersecting runways, to identify one or more runways of the airport that are suitable for landing by the aircraft.

Processing circuitry 410 may be configured to execute LAHSO module 404 to calculate a respective RLL for each of the one or more runways under evaluation based on information such as runway surface conditions, Digital Automatic Terminal Information Service (D-ATIS) information, situational data, current aircraft state data, and/or any other suitable information. LAHSO module 404 may determine and/or retrieve such information by accessing one or more external data sources, such as databases stored in the avionic and/or the flight management system of the aircraft, and/or one or more external systems (e.g., using communication interface(s) 440), such as weather station 130 and/or ATIS station 140 shown in FIG. 1.

The situational data used by LAHSO module 404 to calculate the RLL for the aircraft to land on a runway may include wind direction and speed, outside air temperature, dew point, air pressure, visibility, and the like. LAHSO module 404 may access such runway information may receiving a Meteorological Aerodrome Report (METAR) and/or D-ATIS information from weather station 130 and/or ATIS station 140.

The runway surface conditions of a runway used by LAHSO module 404 to calculate the RLL for the aircraft to land on a runway may include static runway information such as runway elevation, runway slope, runway dimensions, runway coordinates and thresholds, runway surface type, and the like. LAHSO module 404 may access such runway information from data sources such as NavDB 470.

The runway surface conditions of a runway used by LAHSO module 404 to calculate the RLL for the aircraft to land on a runway may also include dynamic runway information such as a runway friction measurement, runway contamination information (e.g., ice, snow, slush, standing water, etc.), a runway moisture level, and the like. LAHSO module 404 may communicate with external systems, such as ATIS station 140 and/or weather station 130 shown in FIG. 1 via communication interface(s) 340, to receive such runway information.

The current aircraft state data used by LAHSO module 404 to calculate a respective RLL for the aircraft to land each of the one or more runways may include the aircraft category, aircraft type, aircraft weight, current aircraft speed, aircraft configuration, thrust reverser health, brake system health, and the like. In some examples, LAHSO module 404 may access FMS 402 to access aircraft category and/or aircraft type, planned and current speeds of the aircraft, current flight plan data, and the like. LAHSO module 404 may also access various on-board systems and sensors of the aircraft, such as aircraft weight and balance system, air data computers, landing gear and aircraft configuration sensors, an electronic centralized aircraft monitor (ECAM), brake control systems, aircraft condition monitoring system, central maintenance computers, centralized aircraft monitoring systems, and the like to determine current aircraft state data such as aircraft configuration, thrust reverser health, brake system health, and the like.

Processing circuitry 410 may be configured to execute LAHSO module 404 to determine a respective Available Landing Distance (ALD), also referred to as Landing Distance Available (LDA), which is the length of the runway that is declared available and suitable for the ground run of an aircraft landing, for each of the runways under evaluation. In some examples, NavDB 470 may store the ALDs of runways, and LAHSO module 4043 may access NavDB 470 to lookup or otherwise determine the respective ALDs for each of the runways under evaluation.

One or more of the runways being evaluated by LAHSO module 404 may be intersecting runways in which the runway intersects another runway. Processing circuitry 410 may be configured to execute LAHSO module 404 to determine, for each intersecting runway being evaluated, a designated hold short point of the runway. In some examples, an Airport Moving Map Database (AMMDB), which may be stored in memory 420, may store information regarding the designated hold short points of runways, and LAHSO module 404 may access the AMMDB to lookup or otherwise determine respective hold short points for each of the intersecting runways under evaluation. LAHSO module 404 may adjust the respective ALD for each of the intersecting runway based on the designated hold short point for the intersecting runway so that, for each intersecting runway, the respective ALD ends at or before the designated hold short point for the intersecting runway.

Processing circuitry 410 may be configured to execute LAHSO module 404 to compare, for each of the runways under evaluation, the RLL for the aircraft to land on the runway against the ALD of the runway. In case of intersecting runways, the respective ALD of each of the intersecting runways may be an adjusted ALD that end at or before the designated hold short point for the intersecting runway, as described above. LAHSO module 404 may determine, for each of the runways under evaluation, whether the RLL for the aircraft to land on the runway is shorter than the ALD of the runway. If LAHSO module 404 determines that the RLL for the aircraft to land on a runway is shorter than the ALD of the runway, LAHSO module 404 may determine that the runway is eligible for landing selection by the aircraft.

LAHSO module 404 may therefore determine, based on comparing, for each of one or more intersecting runways under evaluation, the RLL for the aircraft to land on the respective intersecting runway and the adjusted ALD of the respective intersecting runway, an intersecting runway on which the aircraft can land and hold short of the designated hold short point of the intersecting runway.

Processing circuitry 410 may be configured to execute LAHSO module 404 to transmit, via communication interface(s) 440 and to the ATC system for the airport, an indication of the intersecting runway of the airport on which the aircraft can land and hold short of the designated hold short point of the intersecting runway. In some examples, LAHSO module 404 may transmit the indication of the intersecting runway as part of a landing clearance request to request clearance to land on the indicated runway. The landing clearance request may be a LAHSO clearance request to request clearance to perform a LAHSO to land on the runway and to hold short of the designated hold short point for the runway.

Processing circuitry 410 may be configured to execute LAHSO module 404 to, in response to receiving the landing clearance to land on the runway, automatically synchronize approach information for landing on the runway with the flight management system of the aircraft and/or applications of the avionics of the aircraft. The approach information may include navigation and guidance data for landing on the runway. Processing circuitry 410 may also be configured to execute LAHSO module 404 to provide the information regarding the RLL and adjusted ALD to supplementary runway alerting and advisory systems of the aircraft, such as a Runway Awareness and Advisory System (RAAS), a Runway Overrun Awareness and Alerting System (ROAAS), and the like.

Processing circuitry 410 may be configured to execute one or more of avionics applications 422 to output landing information used by the pilot of the aircraft. One or more of avionics applications 422 may output the landing information for display at one or more displays, such as output device(s) 460. Such landing information may include runway selection information, landing parameters, and the like. Presenting the landing information at the one or more displays may enable the flight crew of the aircraft to select and/or synchronize the chosen landing approach with the onboard landing system.

Processing circuitry 410 may also be configured to execute one or more of avionics applications 422 to determine landing configuration information for the aircraft to perform the LAHSO to land on the designated runway, and may output the determined landing configuration information (e.g., at output device(s) 460). The landing configuration information may include aircraft configuration such as auto brake configuration, reverse thrust setting, slats setting, flaps position, and the like, approach speed, and any other suitable landing configuration.

The one or more of avionics applications 422 monitor the aircraft in rea-time as the aircraft descends to land on the designated runway, and to output real-time landing guidance information to the pilot of the aircraft. The one or more of avionics applications 422 may determine a glide path for the aircraft to safety land at the designated runway and to stop before reaching the designated hold short point for the runway. The one or more of avionics applications 422 may, based on the glide path, monitor the aircraft for deviations from the glide path, and may therefore determine real-time landing guidance information based on the glide path and/or deviations from the glide path.

The real-time landing guidance information may include glide slope alerts (e.g., “too low”, “too high”, “unstable”, etc.), altitude callouts (e.g., “100 feet”, “50 feet”, etc.), runway status and runway remaining (e.g., 500 feet) to the designated hold short point for the runway, stability warnings, ground proximity alerts, surface situation alerts, visual cues, and the like. Such visual cues may include a glide scope indicator that indicates the pilot to pitch the nose of the aircraft up if one or more of avionics applications 422 determines that the aircraft is below the glide path, or that indicates the pilot to pitch the nose of the aircraft down if one or more of avionics applications 422 determines that the aircraft is above the glide path. The visual cues may also include flight director bars that provide pitch and roll commands for the aircraft to return to glide path, deviation indicators that graphically show glide path deviation, and the like. The one or more of avionics applications 422 may output such real-time landing guidance information by outputting audio (e.g., voice output) that contains such real-time landing guidance information at one or more audio output devices (e.g., a speaker device, a headset, etc.) of output device(s) 460, and/or may output such real-time landing guidance information for display at output device(s) 460.

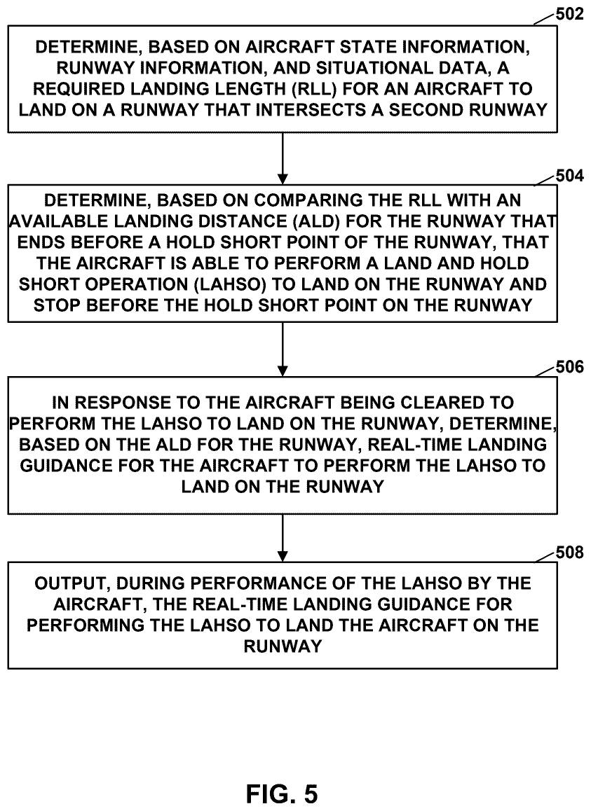

FIG. 5 is a flowchart showing an example process for assisting an aircraft to perform a LAHSO, in accordance with aspects of this disclosure. The example process will be described with respect to a generic computing system. The generic computing system may, for example, correspond to one of or a combination of avionics 110 and EFB 120, but the techniques of FIG. 5 are not limited to specific systems or devices.

As shown in FIG. 5, processing circuitry of a computing device onboard an aircraft 102 may determine, based on aircraft state information, runway information, and situational data, a required landing length (RLL) for the aircraft 102 to land on a runway that intersects a second runway (502). The first computing device may, for example, be avionics 110 of the aircraft or be EFB 120 onboard the aircraft 102.

The runway information may include one or more of: runway friction measurement, runway contamination information, runway moisture level, runway slope, or runway elevation. The aircraft state information may include one or more of: aircraft category, aircraft weight, aircraft speed, aircraft configuration, thrust reverser health, or brake system health. The situational data may include one or more of: wind direction, wind speed, outside air temperature, visibility, or meteorological data.

The processing circuitry may determine, based on comparing the RLL with an available landing distance (ALD) for the runway that ends before a hold short point of the runway, that the aircraft 102 is able to perform a Land And Hold Short Operation (LAHSO) to land on the runway and stop before the hold short point on the runway (504). In some examples, the processing circuitry may determine the ALD of a full length of the runway, wherein the full length of the runway intersects the second runway, and may adjust the ALD to end before the hold short point for the runway. In some examples, the processing circuitry may determine that the aircraft 102 is able to perform the LAHSO without receiving a LAHSO clearance request from air traffic control. In some examples, the processing circuitry may provide the RLL and the ALD for the runway that ends before the hold short point of the runway to a supplementary runway alerting and advisory system for the aircraft.

The processing circuitry may, in response to the aircraft 102 being cleared to perform the LAHSO to land on the runway, determine, based on the ALD for the runway, real-time landing guidance information for the aircraft 102 to perform the LAHSO to land on the runway (506).

To determine the real-time landing guidance information for the aircraft 102, the processing circuitry may determine a glide path for the aircraft 102 to land at the runway and to stop before reaching the hold short point for the runway. The processing circuitry may monitor, based on the glide path, the aircraft 102 for deviations from the glide path. The processing circuitry may determine the landing guidance information based on the deviations from the glide path.

The processing circuitry may output, during performance of the LAHSO by the aircraft 102, the real-time landing guidance information for performing the LAHSO to land the aircraft 102 on the runway (508). In some examples, to output the real-time landing guidance information for performing the LAHSO to land the aircraft 102 on the runway, the processing circuitry may output, for display at a cockpit display, one or more visual cues that indicate the aircraft 102 is deviating from the glide path, wherein the one or more visual cues include one or more of: a glide scope indicator, command bars, or a vertical deviation indicator.

In some examples, the processing circuitry may, in response to the aircraft 102 being cleared to perform the LAHSO to land on the runway, determine, based on the ALD for the runway, aircraft landing configuration information for the aircraft 102 to perform the LAHSO to land on the runway. The aircraft landing configuration includes one or more of: auto brake configuration, reverse thrust setting, slats setting, or flaps position. The processing circuitry may output, during performance of the LAHSO by the aircraft 102, the aircraft landing configuration information.

The following numbered clauses illustrate one or more aspects of the devices and techniques described in this disclosure.

Clause 1. A computer-implemented method comprising: determining, by processing circuitry of a computing system onboard an aircraft and based on aircraft state information, runway information, and situational data, a required landing length (RLL) for the aircraft to land on a runway that intersects a second runway; determining, by the processing circuitry and based on comparing the RLL with an available landing distance (ALD) for the runway that ends before a hold short point of the runway, that the aircraft is able to perform a Land And Hold Short Operation (LAHSO) to land on the runway and stop before the hold short point on the runway; in response to the aircraft being cleared to perform the LAHSO to land on the runway, determining, by the processing circuitry and based on the ALD for the runway, real-time landing guidance information for the aircraft to perform the LAHSO to land on the runway; and outputting, by the processing circuitry and during performance of the LAHSO by the aircraft, the real-time landing guidance information for performing the LAHSO to land the aircraft on the runway.

Clause 2. The method of clause 1, further comprising: in response to the aircraft being cleared to perform the LAHSO to land on the runway, determining, by the processing circuitry and based on the ALD for the runway, aircraft landing configuration information for the aircraft to perform the LAHSO to land on the runway, wherein the aircraft landing configuration information includes one or more of: auto brake configuration, reverse thrust setting, slats setting, or flaps position; and outputting, by the processing circuitry and during performance of the LAHSO by the aircraft, the aircraft landing configuration information.

Clause 3. The method of any of clauses 1 and 2, wherein determining the real-time landing guidance information for the aircraft further comprises: determining, by the processing circuitry, a glide path for the aircraft to land at the runway and to stop before reaching the hold short point for the runway; monitoring, by the processing circuitry and based on the glide path, the aircraft for deviations from the glide path; and determining, by the processing circuitry, the landing guidance information based on the deviations from the glide path.

Clause 4. The method of clause 3, wherein outputting the real-time landing guidance information for performing the LAHSO to land the aircraft on the runway further comprises: outputting, by the processing circuitry and for display at a cockpit display, one or more visual cues that indicate the aircraft is deviating from the glide path, wherein the one or more visual cues include one or more of: a glide scope indicator, command bars, or a vertical deviation indicator.

Clause 5. The method of any of clauses 1-4, wherein determining that the aircraft is able to perform the LAHSO to land on the runway and stop before the hold short point on the runway further comprises: determining, by the processing circuitry, that the aircraft is able to perform the LAHSO without receiving a LAHSO clearance request from air traffic control.

Clause 6. The method of any of clauses 1-5, further comprising: determining, by the processing circuitry, the ALD of a full length of the runway, wherein the full length of the runway intersects the second runway; and adjusting, by the processing circuitry, the ALD to end before the hold short point for the runway.

Clause 7. The method of any of clauses 1-6, further comprising: providing, by the processing circuitry, the RLL and the ALD for the runway that ends before the hold short point of the runway to a supplementary runway alerting and advisory system for the aircraft.

Clause 8. The method of any of clauses 1-7, wherein: the runway information include one or more of: runway friction measurement, runway contamination information, runway moisture level, runway slope, or runway elevation; the aircraft state information include one or more of: aircraft category, aircraft weight, aircraft speed, aircraft configuration, thrust reverser health, or brake system health; and the situational data include one or more of: wind direction, wind speed, outside air temperature, visibility, or meteorological data.

Clause 9. The method of any of clauses 1-8, wherein the computing system comprises at least one of: an electronic flight bag or avionics of the aircraft.

Clause 10. A computing system onboard an aircraft, the computing system comprising: one or more memories; and processing circuitry coupled to the one or more memories and configured to: determine, based on aircraft state information, runway information, and situational data, a required landing length (RLL) for the aircraft to land on a runway that intersects a second runway; determine, based on comparing the RLL with an available landing distance (ALD) for the runway that ends before a hold short point of the runway, that the aircraft is able to perform a Land And Hold Short Operation (LAHSO) to land on the runway and stop before the hold short point on the runway; in response to the aircraft being cleared to perform the LAHSO to land on the runway, determine, based on the ALD for the runway, real-time landing guidance information for the aircraft to perform the LAHSO to land on the runway; and output, during performance of the LAHSO by the aircraft, the real-time landing guidance information for performing the LAHSO to land the aircraft on the runway.

Clause 11. The computing system of clause 10, wherein the processing circuitry is further configured to: in response to the aircraft being cleared to perform the LAHSO to land on the runway, determine, based on the ALD for the runway, aircraft landing configuration information for the aircraft to perform the LAHSO to land on the runway, wherein the aircraft landing configuration information includes one or more of: auto brake configuration, reverse thrust setting, slats setting, or flaps position; and output during performance of the LAHSO by the aircraft, the aircraft landing configuration information.

Clause 12. The computing system of any of clauses 10 and 11, wherein to determine the real-time landing guidance information for the aircraft, the processing circuitry is further configured to: determine a glide path for the aircraft to land at the runway and to stop before reaching the hold short point for the runway; monitor, based on the glide path, the aircraft for deviations from the glide path; and determine the landing guidance information based on the deviations from the glide path.

Clause 13. The computing system of clause 12, wherein to output the real-time landing guidance information for performing the LAHSO to land the aircraft on the runway, the processing circuitry is further configured to: output, and for display at a cockpit display, one or more visual cues that indicate the aircraft is deviating from the glide path, wherein the one or more visual cues include one or more of: a glide scope indicator, command bars, or a vertical deviation indicator.

Clause 14. The computing system of any of clauses 10-13, wherein to determine that the aircraft is able to perform the LAHSO to land on the runway and stop before the hold short point on the runway, the processing circuitry is further configured to: determine that the aircraft is able to perform the LAHSO without receiving a LAHSO clearance request from air traffic control.

Clause 15. The computing system of any of clauses 10-14, wherein the processing circuitry is further configured to: determine the ALD of a full length of the runway, wherein the full length of the runway intersects the second runway; and adjust the ALD to end before the hold short point for the runway.

Clause 16. The computing system of any of clauses 10-15, wherein the processing circuitry is further configured to: provide the RLL and the ALD for the runway that ends before the hold short point of the runway to a supplementary runway alerting and advisory system for the aircraft.

Clause 17. The computing system of any of clauses 10-16, wherein: the runway information include one or more of: runway friction measurement, runway contamination information, runway moisture level, runway slope, or runway elevation; the aircraft state information include one or more of: aircraft category, aircraft weight, aircraft speed, aircraft configuration, thrust reverser health, or brake system health; and the situational data include one or more of: wind direction, wind speed, outside air temperature, visibility, or meteorological data.

Clause 18. The computing system of any of clauses 10-17, wherein the computing system comprises at least one of: an electronic flight bag or avionics of the aircraft.

Clause 19. A non-transitory computer-readable storage medium comprising instructions, that when executed by one or more processors of a computing system onboard an aircraft, cause the one or more processors to: determine, based on aircraft state information, runway information, and situational data, a required landing length (RLL) for the aircraft to land on a runway that intersects a second runway; determine, based on comparing the RLL with an available landing distance (ALD) for the runway that ends before a hold short point of the runway, that the aircraft is able to perform a Land And Hold Short Operation (LAHSO) to land on the runway and stop before the hold short point on the runway; in response to the aircraft being cleared to perform the LAHSO to land on the runway, determine, based on the ALD for the runway, real-time landing guidance information for the aircraft to perform the LAHSO to land on the runway; and output, during performance of the LAHSO by the aircraft, the real-time landing guidance information for performing the LAHSO to land the aircraft on the runway.

Clause 20. The non-transitory computer-readable storage medium of clause 19, wherein the one or more processors are further configured to: in response to the aircraft being cleared to perform the LAHSO to land on the runway, determine, based on the ALD for the runway, aircraft landing configuration information for the aircraft to perform the LAHSO to land on the runway, wherein the aircraft landing configuration information includes one or more of: auto brake configuration, reverse thrust setting, slats setting, or flaps position; and output during performance of the LAHSO by the aircraft, the aircraft landing configuration information.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A computer-implemented method comprising:
determining, by processing circuitry of a computing system onboard an aircraft and based on aircraft state information, runway information, and situational data, a required landing length (RLL) for the aircraft to land on a runway that intersects a second runway;
determining, by the processing circuitry and based on comparing the RLL with an available landing distance (ALD) for the runway that ends before a hold short point of the runway, that the aircraft is able to perform a Land And Hold Short Operation (LAHSO) to land on the runway and stop before the hold short point on the runway;
in response to the aircraft being cleared to perform the LAHSO to land on the runway, determining, by the processing circuitry and based on the ALD for the runway, real-time landing guidance information for the aircraft to perform the LAHSO to land on the runway; and
outputting, by the processing circuitry and during performance of the LAHSO by the aircraft, the real-time landing guidance information for performing the LAHSO to land the aircraft on the runway.

2. The method of claim 1, further comprising:
in response to the aircraft being cleared to perform the LAHSO to land on the runway, determining, by the processing circuitry and based on the ALD for the runway, aircraft landing configuration information for the aircraft to perform the LAHSO to land on the runway, wherein the aircraft landing configuration information includes one or more of: auto brake configuration, reverse thrust setting, slats setting, or flaps position; and
outputting, by the processing circuitry and during performance of the LAHSO by the aircraft, the aircraft landing configuration information.

3. The method of claim 1, wherein determining the real-time landing guidance information for the aircraft further comprises:
determining, by the processing circuitry, a glide path for the aircraft to land at the runway and to stop before reaching the hold short point for the runway;
monitoring, by the processing circuitry and based on the glide path, the aircraft for deviations from the glide path; and
determining, by the processing circuitry, the landing guidance information based on the deviations from the glide path.

4. The method of claim 3, wherein outputting the real-time landing guidance information for performing the LAHSO to land the aircraft on the runway further comprises:
outputting, by the processing circuitry and for display at a cockpit display, one or more visual cues that indicate the aircraft is deviating from the glide path, wherein the one or more visual cues include one or more of: a glide scope indicator, command bars, or a vertical deviation indicator.

5. The method of claim 1, wherein determining that the aircraft is able to perform the LAHSO to land on the runway and stop before the hold short point on the runway further comprises:
determining, by the processing circuitry, that the aircraft is able to perform the LAHSO without receiving a LAHSO clearance request from air traffic control.

6. The method of claim 1, further comprising:
determining, by the processing circuitry, the ALD of a full length of the runway, wherein the full length of the runway intersects the second runway; and
adjusting, by the processing circuitry, the ALD to end before the hold short point for the runway.

7. The method of claim 1, further comprising:
providing, by the processing circuitry, the RLL and the ALD for the runway that ends before the hold short point of the runway to a supplementary runway alerting and advisory system for the aircraft.

8. The method of claim 1, wherein:
the runway information include one or more of: runway friction measurement, runway contamination information, runway moisture level, runway slope, or runway elevation;
the aircraft state information include one or more of: aircraft category, aircraft weight, aircraft speed, aircraft configuration, thrust reverser health, or brake system health; and
the situational data include one or more of: wind direction, wind speed, outside air temperature, visibility, or meteorological data.

9. The method of claim 1, wherein the computing system comprises at least one of: an electronic flight bag or avionics of the aircraft.

10. A computing system onboard an aircraft, the computing system comprising:
one or more memories; and
processing circuitry coupled to the one or more memories and configured to:
determine, based on aircraft state information, runway information, and situational data, a required landing length (RLL) for the aircraft to land on a runway that intersects a second runway;
determine, based on comparing the RLL with an available landing distance (ALD) for the runway that ends before a hold short point of the runway, that the aircraft is able to perform a Land And Hold Short Operation (LAHSO) to land on the runway and stop before the hold short point on the runway;
in response to the aircraft being cleared to perform the LAHSO to land on the runway, determine, based on the ALD for the runway, real-time landing guidance information for the aircraft to perform the LAHSO to land on the runway; and
output, during performance of the LAHSO by the aircraft, the real-time landing guidance information for performing the LAHSO to land the aircraft on the runway.

11. The computing system of claim 10, wherein the processing circuitry is further configured to:
in response to the aircraft being cleared to perform the LAHSO to land on the runway, determine, based on the ALD for the runway, aircraft landing configuration information for the aircraft to perform the LAHSO to land on the runway, wherein the aircraft landing configuration information includes one or more of: auto brake configuration, reverse thrust setting, slats setting, or flaps position; and
output during performance of the LAHSO by the aircraft, the aircraft landing configuration information.

12. The computing system of claim 10, wherein to determine the real-time landing guidance information for the aircraft, the processing circuitry is further configured to:
determine a glide path for the aircraft to land at the runway and to stop before reaching the hold short point for the runway;
monitor, based on the glide path, the aircraft for deviations from the glide path; and
determine the landing guidance information based on the deviations from the glide path.

13. The computing system of claim 12, wherein to output the real-time landing guidance information for performing the LAHSO to land the aircraft on the runway, the processing circuitry is further configured to:
output, and for display at a cockpit display, one or more visual cues that indicate the aircraft is deviating from the glide path, wherein the one or more visual cues include one or more of: a glide scope indicator, command bars, or a vertical deviation indicator.

14. The computing system of claim 10, wherein to determine that the aircraft is able to perform the LAHSO to land on the runway and stop before the hold short point on the runway, the processing circuitry is further configured to:
determine that the aircraft is able to perform the LAHSO without receiving a LAHSO clearance request from air traffic control.

15. The computing system of claim 10, wherein the processing circuitry is further configured to:
determine the ALD of a full length of the runway, wherein the full length of the runway intersects the second runway; and
adjust the ALD to end before the hold short point for the runway.

16. The computing system of claim 10, wherein the processing circuitry is further configured to:
provide the RLL and the ALD for the runway that ends before the hold short point of the runway to a supplementary runway alerting and advisory system for the aircraft.

17. The computing system of claim 10, wherein:
the runway information include one or more of: runway friction measurement, runway contamination information, runway moisture level, runway slope, or runway elevation;
the aircraft state information include one or more of: aircraft category, aircraft weight, aircraft speed, aircraft configuration, thrust reverser health, or brake system health; and
the situational data include one or more of: wind direction, wind speed, outside air temperature, visibility, or meteorological data.

18. The computing system of claim 10, wherein the computing system comprises at least one of: an electronic flight bag or avionics of the aircraft.

19. A non-transitory computer-readable storage medium comprising instructions, that when executed by one or more processors of a computing system onboard an aircraft, cause the one or more processors to:
determine, based on aircraft state information, runway information, and situational data, a required landing length (RLL) for the aircraft to land on a runway that intersects a second runway;
determine, based on comparing the RLL with an available landing distance (ALD) for the runway that ends before a hold short point of the runway, that the aircraft is able to perform a Land And Hold Short Operation (LAHSO) to land on the runway and stop before the hold short point on the runway;
in response to the aircraft being cleared to perform the LAHSO to land on the runway, determine, based on the ALD for the runway, real-time landing guidance information for the aircraft to perform the LAHSO to land on the runway; and
output, during performance of the LAHSO by the aircraft, the real-time landing guidance information for performing the LAHSO to land the aircraft on the runway.

20. The non-transitory computer-readable storage medium of claim 19, wherein the one or more processors are further configured to:
in response to the aircraft being cleared to perform the LAHSO to land on the runway, determine, based on the ALD for the runway, aircraft landing configuration information for the aircraft to perform the LAHSO to land on the runway, wherein the aircraft landing configuration information includes one or more of: auto brake configuration, reverse thrust setting, slats setting, or flaps position; and
output during performance of the LAHSO by the aircraft, the aircraft landing configuration information.
